(19) United States
(12) Patent Application Publication
(10) Pub. No.: US 2004/0226674 A1
(43) Pub. Date: Nov. 18, 2004

(54) Coating and method for producing coated paper or cardboard

(75) Inventors: Ingo Becker, Koln (DE); Bernd Bohnenkamp, Dusseldorf (DE); Volker Faethke, Dusseldorf (DE); Werner Kogler, Olten (CH)

Correspondence Address: TAYLOR & AUST, P.C., 142 SOUTH MAIN STREET, P. O. BOX 560, AVILLA, IN, 46710, US

(73) Assignee: Voith Paper Patent GmbH

(21) Appl. No.: 10/874,422

(22) Filed: Jun. 23, 2004

Related U.S. Application Data
(63) Continuation of application No. 10/640,480, filed on Aug. 13, 2003.

(30) Foreign Application Priority Data
Feb. 16, 2001 (DE) 101 07 733.5
Sep. 19, 2001 (DE) 101 46 273.5

(51) Int. Cl. B05D 5/12; D21H 19/36

(52) U.S. Cl. 162/135; 427/420; 162/181.1

(57) ABSTRACT

A coating for finishing paper or cardboard, with pigments in an aqueous dispersion including a binding agent in a portion of at least 7 percent by weight, preferably 9 to 15 percent by weight (depending on the pigment percentage). Also included is a thickener in a portion of 0.05 to 0.5 percent by weight, preferably 0.2 to 0.4 percent by weight (depending on the pigment percentage) and one surfactant in a portion of at least 0.1 percent by weight (depending on the pigment percentage), preferably 0.2 to 1 percent by weight. The solid content amounts to 50 to 75 percent by weight, preferably 55 to 65 percent by weight, and wherein the viscosity exhibited is no greater than 2500 mPas, preferably less than 500 mPas (Brookfield 100 UPM, 20° C.). A method for producing coated papers or cardboards, where the coating is thoroughly degassed prior to application.

### BACKGROUND OF THE INVENTION

1. Field of the Invention

The present invention relates to a coating for finishing paper and cardboard and a method for producing coated paper or cardboard.

2. Description of the Related Art

In order to improve surface quality (smoothness, gloss, whiteness, printability, etc.) natural papers are coated with pigment-coats in a-known manner. The coatings contain pigments deflocculated in water (calcium carbonate, kaolin, titanium dioxide, talcum, etc.), the fibers of which are covered after printing for a more uniform image. Depending on the printing process that follows, the coating also contain binding agents, in order to anchor the pigments to the fibers and to each other. The coatings further contain additives like thickeners and supplements to simultaneously produce the required physical properties for the corresponding coating methods.

A so-called curtain-coater for applying pigment-coats is known from DE 197 16 647-A, with which the coat is applied such that it free-falls as a solid curtain by way of a slit-shaped nozzle. This coating method does not, as is the standard with other methods, require any excess coating to be used. Rather, the exact quantity required for the coat is applied. Application by way of a curtain-coater entails special requirements for the coating: a stabile, closed curtain must be achieved, free of gas bubbles. Upon contacting the paper or cardboard line, the coating film will be greatly accelerated. It cannot tear off or open due to this acceleration and the resultant shear forces. Just as importantly, the applied film cannot tear open afterwards while drying. Since the coating can contain almost no air or other gases, it must be able to be degassed effectively in an earlier step of the process. To remove the gas bubbles from the coating, the supply container, which supplies the slit-nozzle with coating, is connected to an independent degasification cycle in DE 197 16 647 A. In this way the coating, ready-mixed with all the components, can be degassed.

A method for producing a coated paper is known from EP 0 517 223-B1, where the coating is also applied as a free-falling curtain and is degassed before it is applied. The coating contains at least one pigment and one binding agent, and has a concentration between 50 and 70 percent by weight, whereby the viscosity lies between 700 and 4000 cPs. The coating with all components is subjected to degasification under vacuum, whereby the coating is subjected to shear forces.

### SUMMARY OF THE INVENTION

The present invention provides a coating for the finishing of coatable papers or cardboards which can be applied evenly and without disturbance at high velocities with a curtain-coater.

Then invention comprises, in one form thereof, a coating for finishing paper or cardboard, with pigments in an aqueous dispersion including a binding agent in a portion of at least 7 percent by weight, preferably 9 to 15 percent by weight (depending on the pigment percentage). Also included is a thickener in a portion of 0.05 to 0.5 percent by weight, preferably 0.2 to 0.4 percent by weight (depending on the pigment percentage) and one surfactant in a portion of at least 0.1 percent by weight (depending on the pigment percentage), preferably 0.2 to 1 percent by weight. The solid content amounts to 50 to 75 percent by weight, preferably 55 to 65 percent by weight, and wherein the viscosity exhibited is no greater than 2500 mPas, preferably less than 500 mPas (Brookfield 100 UPM, 20° C.).

In order to be able to be applied with a curtain-coater, the coating must exhibit a viscosity that meets certain requirements. The dynamic surface tension must be greatly reduced, while at the same time an unacceptably great increase in the formation of foam, as the result of the reduced surface tension, must also be prevented. The coated papers, produced with the coating according to the invention, are particularly suited for printing in an offset printing process. Despite the relatively low viscosity of the coating when it is applied, the coated papers have the surface solidity required by the speed of the offset printing process.

The present invention concerns coatings that have proven to be especially advantageous for specific applications. Calcium carbonate, kaolin, titanium dioxide, or talcum are utilized as the pigment. A calcium carbonate with a particle spectrum of 60%<2 μm is utilized. Alternatively, a calcium carbonate with a particle spectrum of 75%<1 μm is utilized.

The present invention provides a method for producing coated papers or cardboards, where the coating is thoroughly degassed in the aim of achieving a very high quality of coated paper, so that no gas bubbles are found in the coating once it has been applied to prevent them from disturbing the coating. This problem is solved by the present invention in that must an aqueous pigment dispersion is produced and is subjected to degasification. After degasification one or more thickeners and one or more surfactants are mixed into the pigment dispersion under airtight conditions as additives. With the method of the present invention it is possible to degas the coating to the point where significantly less than 1 percent by volume of gas remains in the coating that is to be applied. Extensive removal of the gases prevents that uncoated areas result on the paper or cardboard line when the coating is applied in a free-falling curtain.

The characteristics of the present invention have proven to be especially advantageous in achieving the highest possible degree of degasification of the coating. The binding agent is mixed into the pigment dispersion before degasification. The viscosity of the dispersion is less than 500 mPas (Brookfield 100 UPM, 20° C.) for degasification, preferably less than 200 mPas. The dispersion is sprayed into a container under low pressure for degasification. The aqueous pigment dispersion is subjected to degasification by way of at least two serially provisioned degasification stages before thickener and surfactant are mixed in. The degasification of the coating in individual stages, the mixing in of the surfactant and thickener, and the feeding of the coating to slit-nozzle are executed in a continuous chain, one after the other.

The especially advantageous method according to the present invention allows for extensive removal of the gas-forming components, especially air, even from coatings that are difficult to degas. The aqueous pigment dispersion is subjected to degasification by way of at least two serially provisioned degasification stages before the thickener and surfactant are mixed in. The degasification of the coating in individual stages, the mixing in of the surfactant and thickener, and the feeding of the coating to slit-nozzle are executed in a continuous chain one after the other.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic view of an embodiment for the installation for producing coated paper or cardboard, where the coating is degassed before application, according to the present invention; and

FIG. 2 is a schematic view of an embodiment for an installation with two degassing steps provisioned serially according to the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

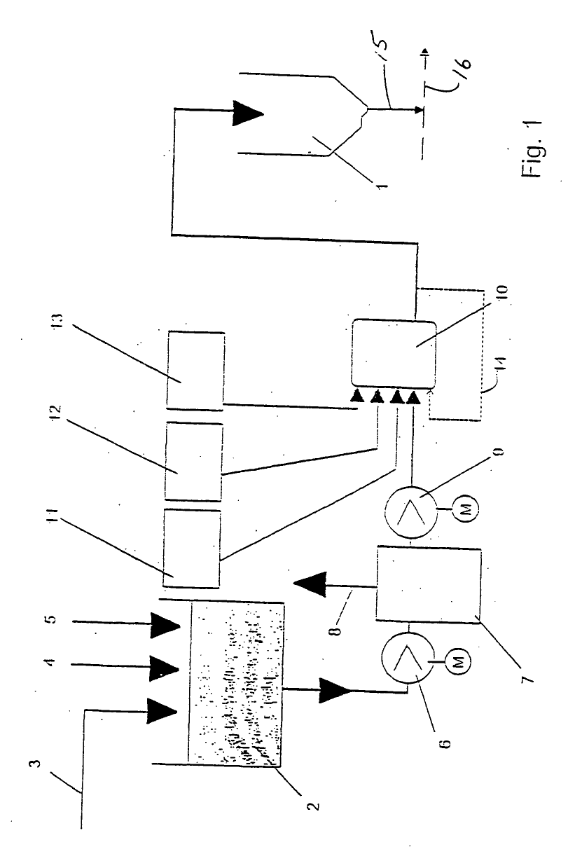

The present invention provides an apparatus and method to produce coated paper or cardboard, wherein the coating is applied by way of a curtain-coater to a moving line of paper or cardboard in a free-falling curtain. Referring now to the drawings, and more particularly to FIG. 1, as application apparatus, curtain-coaters include slit-nozzle 1, which is located above the line and spans its width, and from which the coating is dispensed as a curtain, free-falling onto the line. A suitable curtain-coater and its method of producing coated paper or cardboard is comprehensively described in DE 197 16 647 A.

The coating contains pigments in aqueous dispersion, a binding agent, and at least one thickener and one surfactant as fierier additives. In case they are necessary, further supplements are mixed in as additives to produce certain properties, for example additional substances for improving wetability, curtain stability, etc. Calcium carbonate, kaolin, titanium dioxide, or talcum are preferred as pigments. When calcium carbonate is used, precipitated carbonate (PCC) or natural calcite, like chalk for example, are utilized. If the coating is applied as a pre-coat, a calcium carbonate with a particle spectrum of 60%<2 μm is used. When it is applied as a cover-coat, a calcium carbonate with a particle spectrum of 75%<1 μm has proven to be especially suitable.

Styrolacrylate and mixed polymers, like Styrolbutadlen-Latex, are used as binding agents. A suitable binding agent is marketed by the company BASF under the name of Acronal. It is important that the dispersion contain a portion of binding agents equal to at least 7 percent by weight, depending on the pigment content. This ensures that for every 100 parts of pigment by weight there are contained also at least 7 parts of binding agent by weight. A portion of binding agent of 9 to 15 percent by weight has proven to be particularly suitable, depending on the portion of pigment.

The coating further contains a thickener as an additive to regulate viscosity, in portions ranging from 0.05 to 0.5 percent by weight, preferably 0.2 to 0.4 percent by weight, depending on the portion of pigment. Polymerized acrylic bonds are used as thickeners, and are, for example, marketed under the name of Sterocoll.

It is characteristic of the present invention that at least 0.1 percent by weight (depending on the portion of pigment) of surfactants be included. Preferably 0.2 to 1 percent by weight of surfactants are added. They greatly reduce the dynamic surface tension of the coating, so that the curtain of coating does not tear off or open during application with a curtain-coater. A suitable surfactant is marketed under the name of Plurafac by the company BASF.

The solid content of the coating is 50 to 75 percent by weight, preferably 55 to 65 percent by weight. The viscosity of the coating during application may not exceed certain values. For this reason, the coating has a maximum viscosity of 2500 mPas (Brookfield 100 UPM, 20° C.), preferably less than 500 mPas (Brookfield 100 UPM, 20° C.).

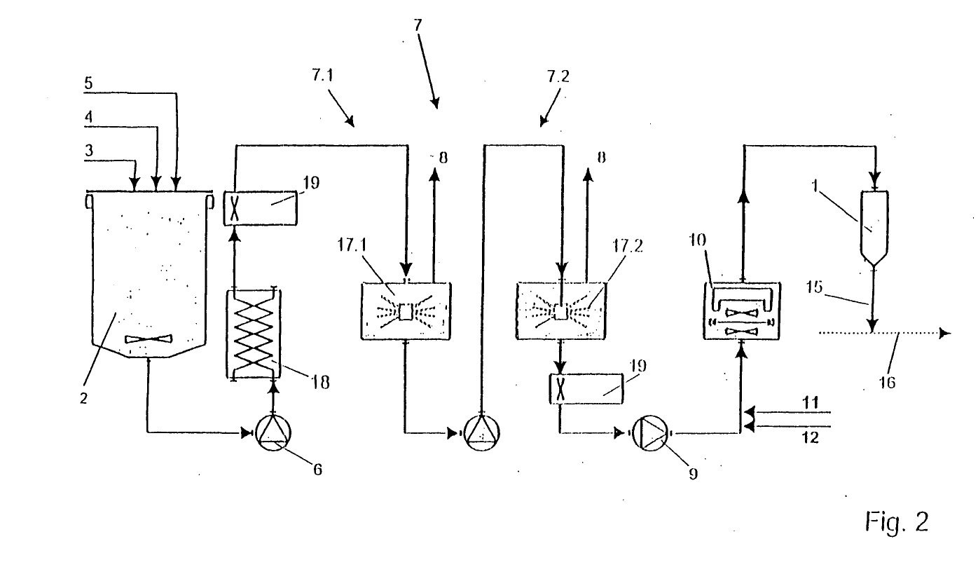

Both of the embodiments represented in FIGS. 1 and 2 serve to produce coated paper or cardboard in that free-falling curtain 15 of coating is applied to moving paper or cardboard line 16. The degassed coating is fed to slit-nozzle 1, out of which curtain 15 falls.

For the preparation of the coating, an aqueous pigment dispersion is first produced in supply container 2. For this example, pigments 3 are mixed with added water 4 until the desired solid content and the desired viscosity are achieved. The viscosity of the pigment dispersion is preferably kept very low for the degasification. It exhibits less than 500 mPas (Brookfield 100 UPM, 20° C.), preferably less than 200 mPas (Brookfield 100 UPM 20° C.). Calcium carbonates, kaolin, titanium dioxide, or talcum are preferred as pigments. It is preferable that binding agents are also be added to container 2, if this does not have negative impact on the degasification. Otherwise the binding agent is mixed in after degasification. In the case that it is necessary, farther supplements are mixed in as additives to produce desired properties of the coating, for example additional substances for improving wetability or the stability of the curtain, or as brighteners. The pigment dispersion, containing the binding agents and other additives that may be utilized under various circumstances is pumped out of supply container 2 by way of metering pump 6 and fed to degasification apparatus 7.

In the installation according to FIG. 1, degasification apparatus 7 includes a container into which the dispersion is sprayed under low pressure. This allows for gases 8, air in particular, which are separated from the dispersion, to be released from the container. So that the degasable components are separated from the dispersion the dispersion is distributed over a large surface at very low absolute pressure (approximately 0.05 bar). It is preferred that the increase in the size of the surface area results through spraying by way of jets, but centrifugal distributors. etc. can also be used.

The pigment dispersion (including the binding agent in the current example) is then propelled into mixing apparatus 10 by metering pump 9. Thickener 11 and surfactant 12 are mixed in under airtight conditions in mixing apparatus 10. In case further supplements 13 are added, these are also mixed in under airtight conditions in mixing apparatus 10. The individual components of the coating are homogenously mixed in mixing apparatus 10, whereby the viscosity is raised through the addition of thickener ii for the coating process that follows. The coating is given a maximum viscosity of 2500 mPas, with a preferred viscosity of less than 500 mPas (Brookfield 100 UPM, 20° C.). Feedback 14 can provide diagnostics on the pigment dispersion exiting mixing apparatus 10. The finished coating mixture is then fed to slit-nozzle 1, out of which it exits as a free-falling curtain.

In the installation according to FIG. 2, the degasification apparatus includes at least two serially provisioned degasification stages 7.1, 7.2 in which the pigment dispersion undergoes continual degasification, in the first and then the next stage, before thickener 11 and surfactant 12 are added under air-tight conditions. The degasification is preferably conducted in two or three stages. Coatings that are especially difficult to degas are degassed in up to five stages, as necessary.

Each degasification stage 7.1, 7.2 preferably includes one spray degasser 17.1, 17.2 with a container that can be evacuated, in which the dispersion is sprayed under low pressure so as to increase the size of the surface area. So that the degasable components are separated from the dispersion, the spraying occurs at a very low absolute pressure (approximately 0.05 bar). Gases 8, which are separated from the dispersion, are suctioned off in each stage. Rotating distributor disks can alternatively be implemented to enlarge the surface area or distributor disks can ram in alternating directions. Before fist degasification stage 7.1, the desired temperature of the pigment dispersion is first produced by way of temperature regulator 18 through heating or cooling. The gas content of the dispersion is measured before and after the degasification by way of density measurement device 19.

From second degasification stage 7.2 the degassed pigment dispersion is propelled into mixing apparatus 10 by metering pump 9. In mixing apparatus 10 thickeners 11 and surfactants 12 are mixed in under airtight conditions, and the individual components of the coating are mixed intensively. The finished and degassed coating mixture is then fed to slit-nozzle 1.

Degasification of the coating in stages 7.1, 7.2, the mixing in of surfactants 111 and thickener 12, and the feeding of the coating to slit-nozzle 1 occur serially one after the other, in a continuous chain.

While this invention has been described as having a preferred design, the present invention can be further modified within the spirit and scope of this disclosure. This application is therefore intended to cover any variations uses, or adaptation of the invention using its general principles. Further, this application is intended to cover such departures from the present disclosure as come within known or customary practice in the art to which this invention pertains and which fall within the limits of the appended claims.

1-11. (Cancelled)

12. A method for producing coated paper or cardboard, comprising the steps of:
producing a coating pigment in an aqueous dispersion;
degasifying said aqueous dispersion of said coating pigment;
mixing at least one thickener and at least one surfactant into said aqueous dispersion of said coating pigment under air-tight conditions after said degasifying step;
adding at least one binding agent; and
applying said coating pigment in said aqueous dispersion to one of a moving paper line and a cardboard line in a free-falling curtain.

13. The method of claim 12, wherein said binding agent is mixed into said coating pigment in said aqueous dispersion before said degasifying step.

14. The method of claim 12, wherein a viscosity of said aqueous dispersion of said coating pigment is less than 500 mPas (Brookfield 100 UPM, 20° C.) during said degasifying step.

15. The method of claim 14, wherein said viscosity is less than 200 mPas.

16. The method of claim 12, wherein said coating pigment in said aqueous dispersion is sprayed into a container under low pressure during said degasification step.

17. The method of claim 12, wherein said degasifying step includes subjecting said coating pigment in said aqueous dispersion to at least two serially provisioned degasification stages.

18. The method of claim 17, further including the step of feeding said coating pigment in said aqueous dispersion to a slit-nozzle, said degasifying step, said mixing step and said feeding step are executed in a sequential continuous chain.

19. A method for producing coated paper or cardboard, comprising the steps of:
producing a coating, said coating including at least one pigment in an aqueous dispersion and having a pigment percentage;
at least one binding agent in a first portion of at least 7 percent by weight, said first portion depending on said pigment percentage;
at least one thickener in a second portion of approximately between 0.05 to 0.5 percent by weight, said second portion depending on said pigment percentage;
at least one surfactant in a third portion of at least 0.1 percent by weight, said third portion depending on said pigment percentage;
a solid content of approximately between 50 to 70 percent by weight; said coating having a viscosity of no greater than 1000 mPas (Brookfield 100 UPM, 20° C.); and
applying said coating to a moving line of one of the paper and the cardboard by way of a curtain-coater in a free-falling curtain.

20. The method of claim 19, wherein said applying step includes pre-coating one of the paper and the cardboard, during said pre-coating both said at least one pigment is at least one of calcium carbonate, kaolin, titanium dioxide, or talcum and said at least one pigment utilizes said calcium carbonate with a particle spectrum of 60%<2 μn.

21. The method of claim 19, wherein said applying step includes cover-coating one of the paper and the cardboard, during said cover-coating both said at least one pigment is at least one of calcium carbonate, kaolin, titanium dioxide, or talcum and said at least one pigment utilizes said calcium carbonate with a particle spectrum of 75%<1 μm.

22. The method of claim 19, further including the steps of:
degasifying said coating;
mixing said at least one thickener and said at least one surfactant into said coating under air-tight conditions after said degasifying step; and
adding said at least one binding agent, all of said degasifying step, said mixing step and said adding step occurring before said applying step.
